(19) United States
(12) Patent Application Publication
(10) Pub. No.: US 2019/0118824 A1
(43) Pub. Date: Apr. 25, 2019

(54) VEHICLE APPARATUS CONTROL DEVICE

(71) Applicant: DENSO CORPORATION, Kariya-city, Aichi-pref. (KR)

(72) Inventors: Hiroyuki MIMURA, Kariya-city (JP); Kiyotaka TAGUCHI, Kariya-city (JP)

(73) Assignees: DENSO CORPORATION, Kariya-city, Aichi-pref. (JP); DENSO CORPORATION, Kariya-city, Aichi-pref. (JP)

(21) Appl. No.: 16/096,455

(22) PCT Filed: Apr. 12, 2017
(86) PCT No.: PCT/JP2017/014976

§ 371 Date: Oct. 25, 2018

(30) Foreign Application Priority Data
Apr. 28, 2016 (JP) 2016-091049

(51) Int. Cl. B60W 40/08; B60W 50/14; G08B 21/06; G08G 1/16; B60K 35/00

(52) U.S. Cl. CPC B60W 40/08; B60W 50/14; G08B 21/06; B60W 2050/146; B60K 35/00; B60W 2040/0827; G08G 1/16

(57) ABSTRACT

A vehicle apparatus control device includes a state detection apparatus, a provision apparatus, and an optimization apparatus. The state detection apparatus detects a drive state of a driver of a vehicle. The provision apparatus, as a vehicle apparatus, provides information to the driver of the vehicle through one of five senses in a predetermined provision manner. The provision apparatus suggests to the driver that the drive state is out of the appropriate range. The optimization apparatus causes the provision apparatus to provide the information by changing the provision manner when the drive state of the driver detected by the state detection apparatus is out of an appropriate range.

### CROSS REFERENCE TO RELATED APPLICATION

This application is based on Japanese Patent Application No. 2016-91049 filed on Apr. 28, 2016, the disclosure of which is incorporated herein by reference.

### TECHNICAL FIELD

The present disclosure relates to a vehicle apparatus control device that performs an operation for maintaining an appropriate state of a driver or the like.

### BACKGROUND ART

Various types of devices, which restore a state of a driver to an awakening state in a case where the driver of a vehicle is in a drowsiness state or the like, have been proposed.

For example, a panel light may be located at a predetermined position in a driver's seat. In this case, when it is detected that the driver is in a state of decrease of attractiveness, the panel light is turned on and a strong light is irradiated to the driver in order to awake the driver.

In another device, indicators, which are capable of performing a flash indication operation, are provided. The indicators are located on the left and right of the driver's seat, and deviate from a central visual field of the driver. When it is detected that the driver is in the state of decrease of attractiveness, the indicators on the left and right alternately flash. The configuration causes a visual line of the driver to move to left and right. Thus, the awakening degree increases.

These types of devices stimulate the driver in order to increase the awakening degree of the driver. Thus, the driver may feel annoyed or feel uncomfortable. In the latter device, the driver moves the visual line to the indicators on the left and right. The visual line of the driver deviates from the front. Thus, there is a possibility of inducing an unfavorable state.

### PRIOR ART LITERATURE

### Patent Literature

### Patent Literature 1: JP 2008-238957 A

### Patent Literature 2: JP 2015-138383 A

### SUMMARY OF INVENTION

It is an object of the present disclosure to provide a vehicle apparatus control device that restores a state of a driver to an awakening state and maintains the awakening state without the driver feeling annoyed when the vehicle apparatus control device detects that the driver is in a state of decrease of attractiveness.

According to an aspect of the present disclosure, a vehicle apparatus control device includes a state detection apparatus, a provision apparatus, and an optimization apparatus. The state detection apparatus detects a drive state of a driver of a vehicle. The provision apparatus, as a vehicle apparatus, provides information to the driver of the vehicle through one of five senses in a predetermined provision manner. The optimization apparatus causes the provision apparatus to provide the information by changing the provision manner when the drive state of the driver detected by the state detection apparatus is out of an appropriate range.

With the above-described configuration, when the drive state of the driver in the vehicle detected by the detection apparatus is out of the appropriate range, the optimization apparatus controls the activated provision apparatus to change the provision manner. With this configuration, the provision manner of the information by the provision apparatus is changed, so that the driver is stimulated through the one of five senses. When the drive state is within an improvable state, the configuration can improve the driver state consciously or unconsciously.

The driver may recognize that the drive state is not appropriate by the change of the provision state. In this case, the driver recognizes that the driver state is out of the appropriate state, so that the drive state can consciously shift to the appropriate state. When the driver does not recognize that the drive state is not appropriate, the driver is stimulated by the change of the provision state, so that the drive state unconsciously shifts to the appropriate state.

In the above-described configuration, when the drive state is out of the appropriate state, the vehicle apparatus control device does not directly communicate to urge the conscious improvement by the notification or the warning of not being within the appropriate state. The vehicle apparatus control device changes the provision manner of the provision apparatus that is activated for providing the information in the compartment. With this configuration, in the natural provision of the information to the driver, the driver recognizes the state of the driver and the state is voluntarily or unconsciously improved. Thus, the configuration can reduce annoyance of the driver and guide to the appropriate state by suppressing the decrease of attractiveness when new information to the driver is provided during driving.

The configuration detects the inappropriate drive state that is not suitable for driving. The inappropriate drive state may include the careless drive, sleepiness, fatigue, the decrease of attractiveness, the decrease of arousal, or the excessive arousal. After the detection, the configuration outputs drive state improvement and maintenance information that guides the driver to improve or maintain the drive state without applying excessive load on the driver.

In the optimization control, a factor that controls the human is incorporated in the information provision of the stimulation of the five senses by the apparatus or content that has been activated. Thus, the configuration can guide the state of the human to the appropriate state for the driving without being annoying (without degrading peripheral visibility or audibility).

### BRIEF DESCRIPTION OF DRAWINGS

The above and other objects, features and advantages of the present invention will become more apparent from the following detailed description made with reference to the accompanying drawings. In the drawings:

FIG. 1 is a block diagram showing a configuration of a first embodiment;

FIG. 2 is a diagram showing an outside view of a front part of a compartment;

FIG. 3 is a flowchart showing an optimization control;

FIG. 4 is an operation explanatory diagram showing factors corresponding to a sense of sight and a sense of hearing among five senses;

FIG. 5 is a first operation explanatory diagram showing a case where a visual control amount in a visual factor of a provision manner by a visual provision apparatus is changed in one of different manners;

FIG. 6 is a second operation explanatory diagram showing a case where the visual control amount in the visual factor of the provision manner by the visual provision apparatus is changed in one of different manners;

FIG. 7 is a third operation explanatory diagram showing a case where the visual control amount in the visual factor of the provision manner by the visual provision apparatus is changed in one of different manners;

FIG. 8 is a diagram showing a basic display screen by a head-up display;

FIG. 9 is a first example diagram showing a display manner changed by the optimization control;

FIG. 10 is a second example diagram showing a display manner changed by the optimization control;

FIG. 11 is a third example diagram showing a display manner changed by the optimization control;

FIG. 12 is a first operation explanatory diagram showing a display manner changed by the optimization control;

FIG. 13 is a second operation explanatory diagram showing a display manner changed by the optimization control;

FIG. 14 is a third operation explanatory diagram showing a display manner changed by the optimization control;

FIG. 15 is a fourth operation explanatory diagram showing a display manner changed by the optimization control;

FIG. 16 is a fifth operation explanatory diagram showing a display manner changed by the optimization control;

FIG. 17 is a sixth operation explanatory diagram showing a display manner changed by the optimization control;

FIG. 18 is a seventh operation explanatory diagram showing a display manner changed by the optimization control;

FIG. 19 is an eighth operation explanatory diagram showing a display manner changed by the optimization control;

FIG. 20 is a ninth operation explanatory diagram showing a display manner changed by the optimization control;

FIG. 21 is a tenth operation explanatory diagram showing a display manner changed by the optimization control;

FIG. 22 is an eleventh operation explanatory diagram showing a display manner changed by the optimization control;

FIG. 23 is a twelfth operation explanatory diagram showing a display manner changed by the optimization control;

FIG. 24 is a thirteenth operation explanatory diagram showing a display manner changed by the optimization control;

FIG. 25 is a fourteenth operation explanatory diagram showing a display manner changed by the optimization control;

FIG. 26 is a fifteenth operation explanatory diagram showing a display manner changed by the optimization control;

FIG. 27 is a sixteenth operation explanatory diagram showing a display manner changed by the optimization control;

FIG. 28 is a first operation explanatory diagram showing a case where an auditory control amount in an auditory factor of a provision manner by an auditory provision apparatus according to a second embodiment is changed in one of different manners;

FIG. 29 is a second operation explanatory diagram showing a case where the auditory control amount in the auditory factor of the provision manner by the auditory provision apparatus according to the second embodiment is changed in one of different manners;

FIG. 30 is a third operation explanatory diagram showing a case where the auditory control amount in the auditory factor of the provision manner by the auditory provision apparatus according to the second embodiment is changed in one of different manners;

FIG. 31 is a first operation explanatory diagram showing an output manner changed by the optimization control of an audio apparatus;

FIG. 32 is a second operation explanatory diagram showing an output manner changed by the optimization control of the audio apparatus;

FIG. 33 is a diagram showing an example configuration of an output manner changed by the optimization control of the audio apparatus;

FIG. 34 is a diagram showing an example configuration of an output manner of a conditioned air changed by an optimization control of an air conditioner;

FIG. 35 is an operation explanatory diagram showing factors corresponding to a sense of touch among five senses;

FIG. 36 is a first operation explanatory diagram showing a case where a tactile control amount in a tactile factor of a provision manner by a tactile provision apparatus is changed in one of different manners;

FIG. 37 is a second operation explanatory diagram showing a case where the tactile control amount in the tactile factor of the provision manner by the tactile provision apparatus is changed in one of different manners; and

FIG. 38 is a third operation explanatory diagram showing a case where the tactile control amount in the tactile factor of the provision manner by the tactile provision apparatus is changed in one of different manners.

### EMBODIMENTS FOR CARRYING OUT INVENTION

### First Embodiment

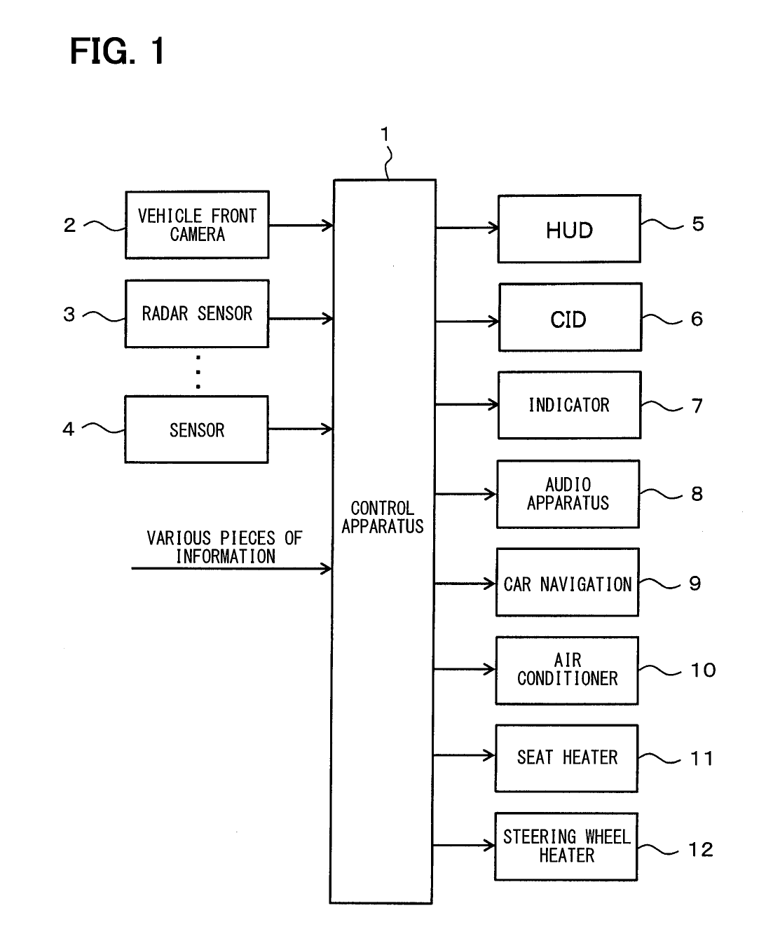

The first embodiment of the present disclosure will be described with reference to FIGS. 1 to 27.

FIG. 1 is a diagram showing a basic configuration of a vehicle apparatus control device. The vehicle apparatus control device is attached to a vehicle. The vehicle apparatus control device detects a state of a driver in a driver's seat. When the vehicle apparatus control device determines that the drive state is out of an appropriate range, the vehicle apparatus control device performs a control for restoring the drive state to an appropriate state. A control apparatus 1 includes a CPU, a ROM, a RAM, an interface circuit, or the like, and functions as an optimization apparatus. In the present embodiment, the control apparatus may be exclusively employed. Alternatively, the control apparatus may be shared with another control apparatus that performs another control.

The control apparatus 1 stores a program for performing an optimization operation, which will be described below, in an internal storage or the like. When a power supply is turned on, the control apparatus 1 reads out the program and repeatedly executes the program at an appropriate timing. The control apparatus 1 is connected to a vehicle front camera 2, a radar sensor 3, a sensor 4, and the like for detecting the drive state of the driver. Vehicle information obtained from various types of sensors provided in the vehicle is input to the control apparatus 1.

The vehicle front camera 2 is provided in the compartment so as to capture an image of the driver. The vehicle front camera 2 functions as a state detection apparatus that analyzes the state of the driver from a face, a driver motion, or the like and determines the drive state. The drive state may include a careless drive, cause of sleepiness or fatigue, a decrease of attractiveness or arousal, or an excessive arousal on the contrary. In this drive state, the driver is in an inappropriate drive state that is unsuitable for driving, so that the driver state needs to be restored to an appropriate drive state. The drive state may be detected from not only the state of the driver but also a vehicle state obtained from the radar sensor 3, the sensor 4, or the vehicle information. Each of the radar sensor 3 and the sensor 4 also functions as the drive state detection apparatus.

Various types of apparatuses capable of being employed for improving the drive state are connected to the control apparatus 1. Although the various types apparatuses described below are employed for improving the drive state, the apparatuses are not provided for improving the drive state. Each of the apparatuses is provided as an apparatus for providing information along with the drive state.

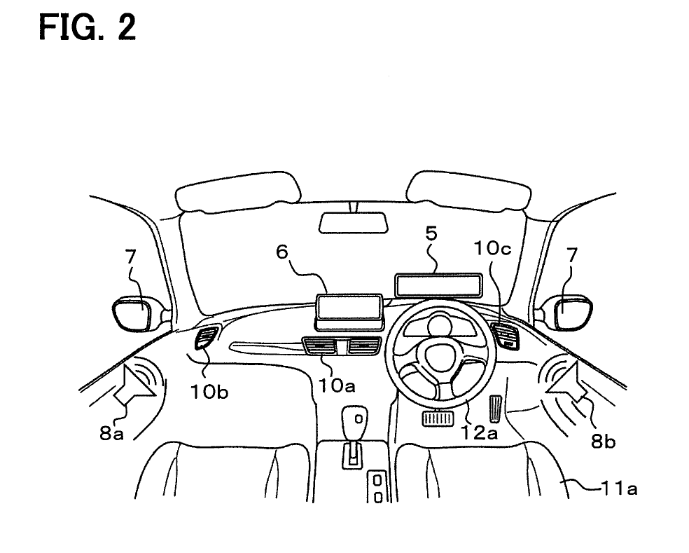

As shown in FIG. 2, a HUD (i.e., Head Up Display) 5 is an apparatus that projects an image from a dashboard in the compartment toward a windshield. The HUD 5 may display information such as speed information, lane information, or drive support information. The HUD 5 displays the information in a transparent state except for the pattern portion, so that the driver is visible in front of the vehicle through the windshield.

A CID (i.e., Center Information Display) 6 is a display apparatus arranged in the upper center part of the dashboard. The CID 6 displays various pieces of information for supporting the vehicle drive, similarly to the HUD 5. The CID 6 may display a map of car navigation 9. An indicator 7 is attached to, for example, a side mirror, and indicates the information by turning on or flashing an LED or the like. Each of the HUD 5, the CID 6, the indicator 7, and the like functions as a provision apparatus that provides the information to the driver using the sense of sight among the five senses.

The audio apparatus 8 is provided as a car stereo, a sound output apparatus of the car navigation 9 or the like. The audio apparatus 8 outputs sound to the compartment by speakers 8a and 8b provided on the both sides of the dashboard or the left and right doors. The audio apparatus 8 functions as a provision apparatus that provides the information to the driver using the sense of hearing among the five senses.

The air conditioner 10 blows hot or cool conditioned air into the compartment from multiple wind outlets 10a, 10b, 10c. An air conditioner control circuit drives and controls the air conditioner 10. A seat heater 11 is heated by a heater provided inside a seated portion of a seat 11a. A steering wheel heater 12 is heated by a heater provided inside a contact portion of a steering wheel 12a. Each of the air conditioner 10, the seat heater 11, and the steering wheel heater 12 functions as a provision apparatus that provides the information to the driver using the sense of touch among the five senses.

In addition, a provision apparatus that provides information such as smell or taste to the driver using the sense of smell or the sense of taste may be employed, which is not shown in the drawings.

The HUD 5, the CID 6, or the like among the various types of provision apparatuses described above is generally in on state during the driving. Thus, an optimization control is performed using the HUD 5, the CID 6, or the like. Another apparatus other than the HUD 5, the CID 6, or the like, which is activated during the driving and is capable of stimulating the driver through one of the five senses, may be employed for performing the optimization control and functions as the provision apparatus.

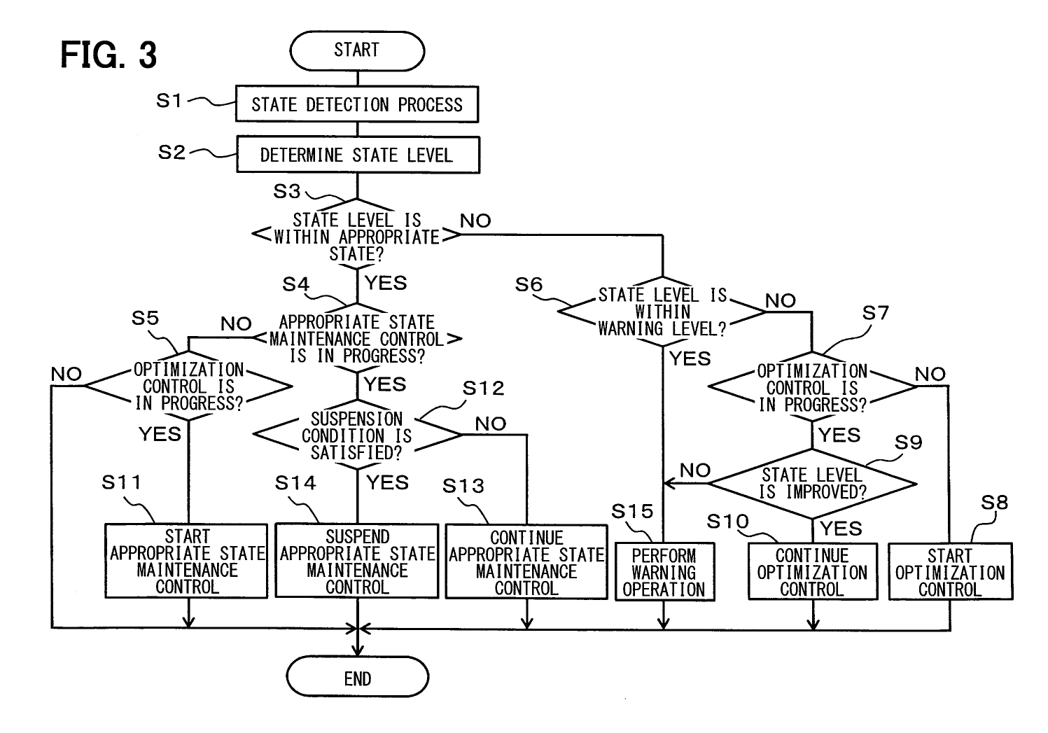

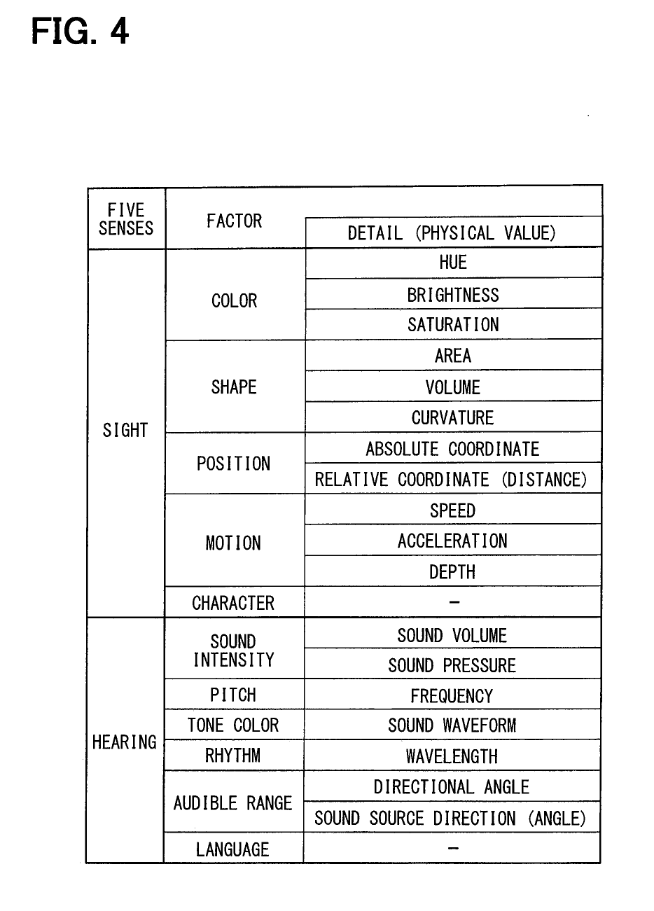

Next, an operation of the present embodiment will be described with reference to FIGS. 3 to 27. In general, the senses recognized as “five senses” are “sight”, “hearing”, “touch”, “smell”, and “taste”. In each sense, a factor that affects a human state control exists. In this embodiment, the optimization control is performed related to a sense of “sight”. As shown in FIG. 4, the factor of the sense of sight may include “color”, “shape”, “position”, “motion”, “character”, or the like.

As shown in FIG. 4, each of the factors of the sense of sight further includes detailed physical factors. The control apparatus 1 performs the optimization control by the display operation of the display apparatus such as the HUD 5, the CID 6, the indicator 7 or the like based on the detailed physical factors. With respect to the information on the display, for “color” of the factor, “hue”, “brightness”, “saturation”, or the like is changed. For “shape” of the factor, “area”, “volume”, “curvature”, or the like is changed. For “position” of the factor, “absolute coordinate”, “relative coordinate”, or the like is changed. For “motion” of the factor, “speed”, “acceleration”, “depth”, or the like is changed. For “character” of the factor, various pieces of stimulation such as deformation, movement, distortion, flash, color change, or the like can be provided. In a change manner of the information, an increase or a decrease of a control amount, a repeat of the change, or the like may be employed.

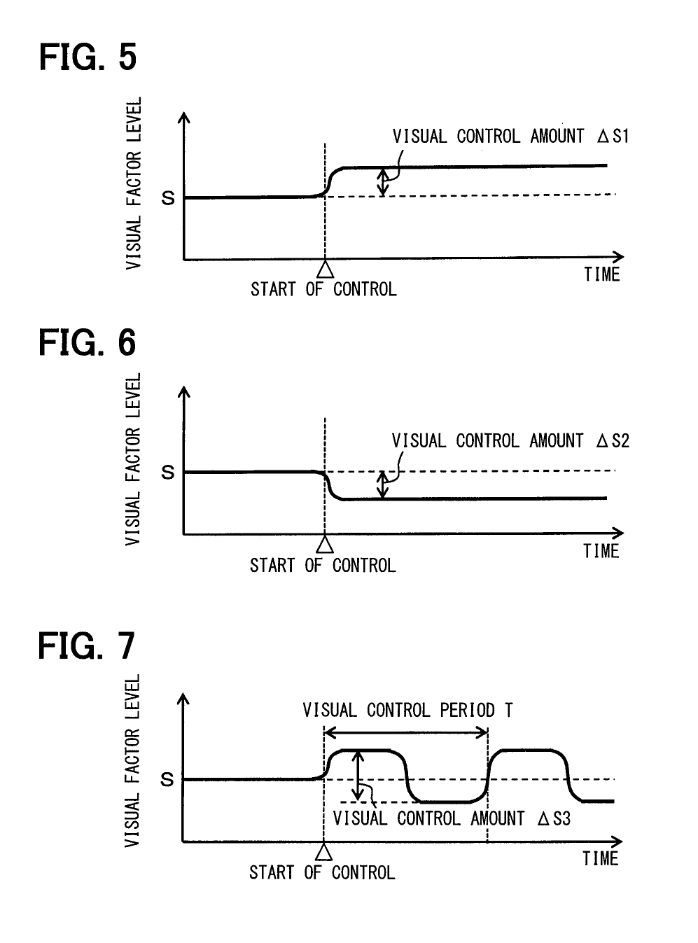

FIGS. 5 and 6 show configurations that changes a level of the factor related to the sense of sight. A level S of the factor is defined as a constant display level. When the optimization control starts, the level of the factor is changed by increasing a visual control amount ΔS1 or decreasing a visual control amount ΔS2. With this configuration, the driver is stimulated to the sense of sight among the five senses by changing the level of the factor.

As shown in FIG. 7, the visual control amount ΔS may be periodically changed by combining the controls shown in FIGS. 5 and 6. In this case, the visual control amount ΔS corresponds to amplitude ΔS3 of the change amount, and the change speed may be set as a control period T. The control amount ΔS3 and the control period T may be appropriately changed.

The level S of the factor or the control amount ΔS may be set as a digital level or an analog level. The level S of the factor or the control amount ΔS may be changed stepwise or continuously.

In this optimization control, the display apparatus does not directly communicate the drive state that is not in the appropriate state, but communicates the drive state by changing the display operation manner. In this embodiment, the information is not provided by performing the display operation in a state of being changed.

The display operation may be performed in a changed manner. In a case, the driver recognizes that the drive state is inappropriate by being stimulated. In another case, the driver does not recognize that the drive state is inappropriate due to the indirect stimulation. When the driver recognizes that the drive state is inappropriate, the drive state shifts to the appropriate state. When the driver does not recognize that the drive state is inappropriate, potential stimulation is unconsciously received to the sense of sight by changing the display state, so that the drive state may shift to the appropriate state.

In the optimization control, the information is not added to the display apparatus which is on display operation. This configuration avoids the driver's attention to the driving from decreasing due to an increase in a load based on the display of the information.

Next, the process of the optimization control will be described with reference to FIG. 3. The control apparatus 1 reads out the optimization control program. When the control apparatus 1 determines that the vehicle is being driven based on various pieces of the vehicle information, the control apparatus 1 executes the program. A well-known technique is employed in the detection operation of the drive state of the driver, so that the description will be omitted. The control apparatus 1 repeatedly executes the program at an appropriate timing during the driving.

In step S1, the control apparatus 1 performs a detection process of the drive state of the driver based on the vehicle front camera 2, the laser sensor 3, the sensor 4, various pieces of the vehicle information or the like. In the detection process of the drive state, the control apparatus 1 detects the inappropriate drive state that is unsuitable for driving. The inappropriate drive state may include the careless drive, sleepiness, fatigue, the decrease of attractiveness, the decrease of arousal, or the excessive arousal. With respect to the detected drive state, the level may be determined using an indicator provided as awareness. In step S2, the control apparatus 1 determines the state level. An appropriate range is set to the state level of the drive state. A certain range within the appropriate range is a target level for the optimization control. When the state level of the drive state deviates greatly from the appropriate range and it becomes difficult to perform the optimization control, measures such as a warning or an operation assistance is performed.

When the state level of the drive state is within the appropriate range, the control apparatus 1 determines YES in step S3 and the process proceeds to step S4. In step S4, the control apparatus 1 determines whether an appropriate state maintenance control is in progress. When the appropriate state maintenance control is not performed, the process proceeds to step S5. In step S5, the control apparatus 1 determines whether the optimization control is performed. When the optimization control is not performed, the control apparatus 1 determines NO in step S5 and the process ends. The above-described flow indicates a case where the drive state is appropriate, so that the optimization control is not required.

Next, a case where the drive state deviates from the appropriate range will be described. In this case, the process proceeds to step S3 through step S1 and step S2 and the control apparatus 1 determines NO in step S3. The process proceeds to step S6 and the control apparatus 1 determines whether the state level is within a warning level. When the state level is out of the warning level, the process proceeds to step S7. In step S7, the control apparatus 1 determines whether the optimization control is performed. When the optimization control is not performed, the control apparatus 1 determines NO in step S7 and the process proceeds to step S8. In step S8, the control apparatus 1 starts the optimization control. Specifically, the control apparatus 1 performs the optimization control operation as described later.

With the optimization control performed, when the state level of the drive state of the driver approaches the appropriate range, the state level is determined to be improved. When the control apparatus 1 executes the program, the process proceeds through step S1 to step S3. When the state level is not within the appropriate range but the state level is improved, the process proceeds through step S6, the control apparatus 1 determines YES in step S7, and the process proceeds to step S9. When the control apparatus 1 determines YES in step S9, the process proceeds to step S10 and continues the optimization control.

Thereafter, the drive state of the driver may be further improved by the optimization control and the state level may become within the appropriate range. In this case, the process proceeds to step S3 through step S1 and step S2 and the control apparatus 1 determines YES in step S3. In the following step S4, the control apparatus 1 determines whether the appropriate state maintenance control is in progress. In this case, the control apparatus 1 is performing the optimization control, so that the control apparatus 1 determines NO in step S4 and the process proceeds to step S5. The control apparatus 1 determines YES in step S5 and the process proceeds to step S10. The control apparatus 1 becomes within the appropriate state, the optimization control shifts to the appropriate state maintenance control. In the appropriate state maintenance control, the control apparatus 1 may continue the same operation as the optimization control. Alternatively, in the appropriate state maintenance control, the control apparatus 1 may cause the optimization process of the optimization control weaker or stronger. Further, the control apparatus 1 may change the control amount of the optimization process based on the state level of the drive state.

When an appropriate state is consecutively detected, the control apparatus 1 is within the appropriate range and performing the appropriate state maintenance control. In this case, the process proceeds to S4 through step S1 to step S3, the control apparatus 1 determines YES in step S4, and the process proceeds to S12. In step S12, the control apparatus 1 determines whether a condition for suspending the appropriate state maintenance control is satisfied. When the suspension condition is not satisfied, the control apparatus 1 determines NO in step S12, the process proceeds to S13, and the control apparatus 1 continues the appropriate state maintenance control.

The condition for suspending the appropriate state maintenance control may be set to elapse of a certain time from the start of the appropriate state maintenance control, or the detection of the favorable state in the level of the drive state within the appropriate range. Alternatively, the suspension condition of the appropriate state maintenance control may be set to various types of conditions.

Thereafter, the control apparatus 1 continues the appropriate state maintenance control. When the suspension condition is satisfied in step S12, the control apparatus 1 determines YES in step S12, and the process proceeds to S14. In step S14, the control apparatus 1 suspends the appropriate state maintenance control which has been performed.

When the state level of the drive state greatly deviates from the appropriate range and is within the warning level, the process proceeds to step S6 through step S1 to S3, the control apparatus 1 determines YES in step S6, and the process proceeds to step S15. In step S15, the control apparatus 1 performs the warning operation. Basically, the warning operation is performed using the HUD 5, the CID 6, the indicator 7, the audio apparatus 8, or the like. In the warning operation, display, sound, buzzer or the like directly attracts the attention of the driver. Alternatively, an exclusive apparatus for attracting the attention may be provided. In addition to the warning operation, as the drive support control, the speed of the vehicle may be reduced or a break may be urged on the display.

When the optimization control is performed as described above but the state level of the drive state is not improved, the optimization control is not affected. In this case, the control apparatus 1 determines NO in step S9, the process proceeds to step S15, and the control apparatus 1 performs the warning operation.

As described above, the control apparatus 1 performs the optimization control operation. Thus, even when the state level of the drive state of the driver is out of the appropriate range, there is a high possibility that the drive state is restored to the appropriate state. In this case, the control apparatus 1 does not directly indicate to the driver that the drive state is out of the appropriate state, but suggests the drive state by changing the display state of the HUD 5 employed in an original purpose. Thus, when the driver notices that the drive state is out of the appropriate state by receiving the stimulation, the configuration can reduce annoyance which the driver feels. When the driver does not notice that the drive state is out of the appropriate state, the configuration can unconsciously urge the driver to shift the drive state to the appropriate state.

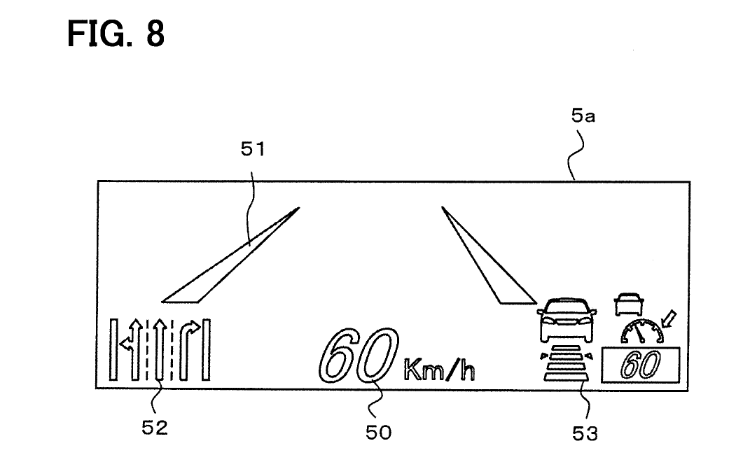

Next, with regard to the optimization control by the display operation using the HUD 5, some examples will be described with reference to FIGS. 8 to 27. A display manner by the HUD 5 is shown in FIG. 8. The HUD 5 projects an image from the dashboard toward the windshield or an exclusive display. With this configuration, the driver is capable of seeing the road surface and the display through the windshield.

As shown in FIG. 8, for example, a speed information item 50, a road surface information item 51, a lane information item 52, a preceding vehicle information item 53, or the like is displayed on a display screen 5a by a white pattern or a colored pattern as necessary. A part of the windshield other than the pattern is transparent. Thus, the driver is capable of seeing the road surface through the windshield. With this configuration, when the driver looks in front through the windshield, the driver is capable of seeing the various pieces of information with the display screen 5a of the HUD 5 overlapped.

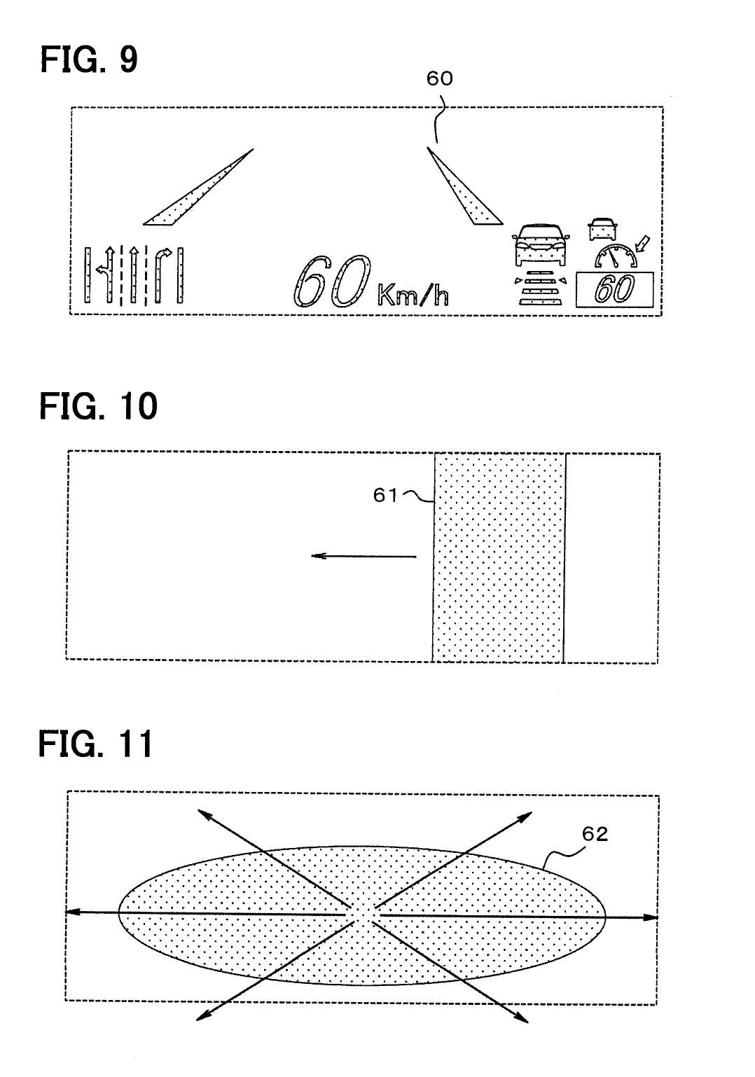

In the optimization control, the control apparatus 1 controls the display state of the HUD 5 and changes the display manner. FIG. 9 shows a pattern 60 indicative of the change of a pattern of each of information items 51 to 53 displayed on the display screen 5a by being colored in another color. In this case, the color of the pattern may be changed, or may become conspicuous by the flashing display. In the flashing display, a change speed may be appropriately set or the change speed may be appropriately changed.

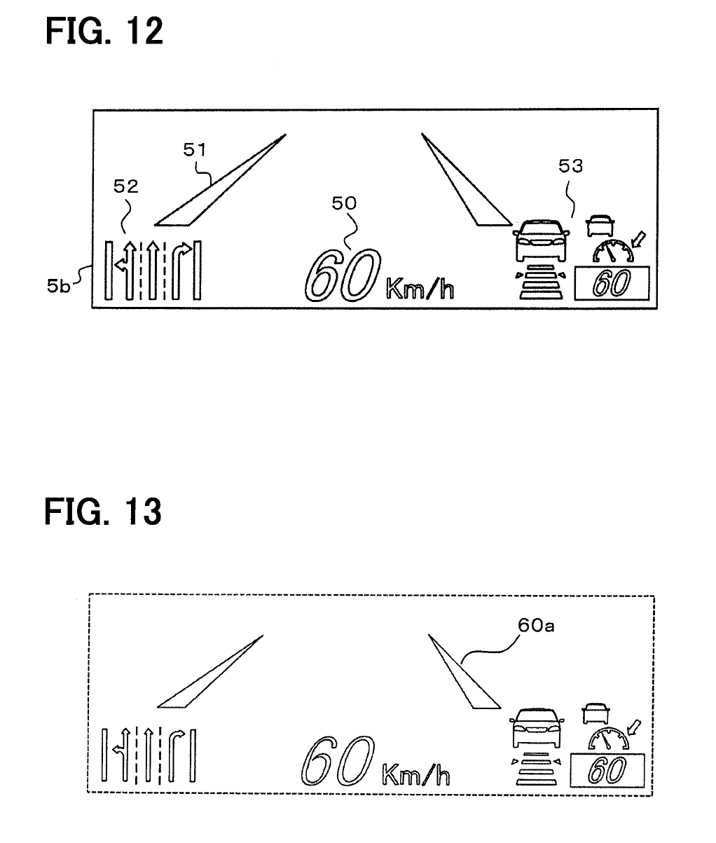

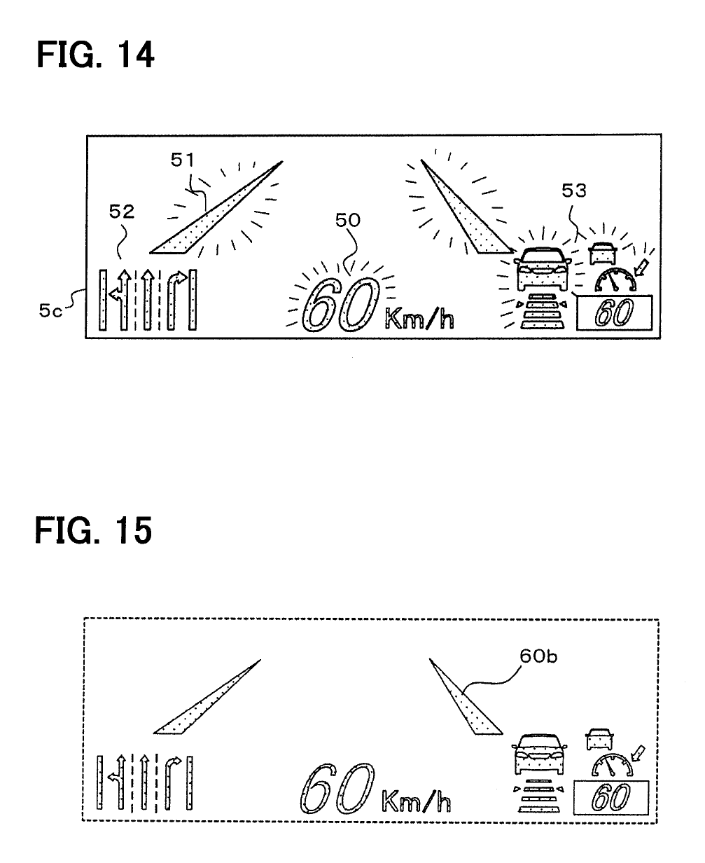

FIGS. 12 to 15 show examples of the display. FIG. 12 shows a screen display state 5b that employs a pattern 60a shown in FIG. 13. FIG. 14 shows a screen display state 5c that employs a pattern 60b shown in FIG. 15. The two patterns are changed to each other. FIG. 13 and FIG. 15 respectively show the patterns 60a and 60b obtained by coloring the above-described pattern 60 in different colors such as yellow and red.

In FIG. 12, the pattern of each of the information items 51 to 53 on the display screen 5a is displayed in yellow, which is colored in the pattern 60a. In FIG. 14, the pattern of each of the information items 51 to 53 on the display screen 5a is displayed in red, which is colored in the pattern 60b. In this configuration, the display in FIG. 12 and the display in FIG. 14 are alternately repeated. With this configuration, the pattern of each of the information items 51 to 53 on the display screen 5a is displayed in a state of being changed, so that the control apparatus 1 is in the optimization control state.

FIG. 10 shows a moving area pattern 61 indicative of a pattern that changes the pattern of each of information items 51 to 53 displayed on the display screen 5a in another color. By moving the moving area pattern 61 from right to left at a predetermined speed, the display state of the pattern of each of the information items 51 to 53 on the display screen 5a may be changed. The moving area pattern 61 has a color or a design, which is different from the pattern of each of the information items 51 to 53 on the display screen 5a. The moving area pattern 61 is moved and the color or the design of the moving area pattern 61 is displayed on the portion overlapping. With this configuration, the display state of the display screen 5a is changed.

As shown in FIG. 10, the moving area pattern 61 has a rectangular shape. Alternatively, the moving area pattern 61 may have a parallelogram shape, a circular shape, an elliptical shape, a predetermined shape, or the like. The color or the design of the moving area pattern 61 may be set appropriately. The moving speed of the moving area pattern 61 may be set appropriately. The moving speed may be constant. Alternatively, the moving speed may be appropriately changed.

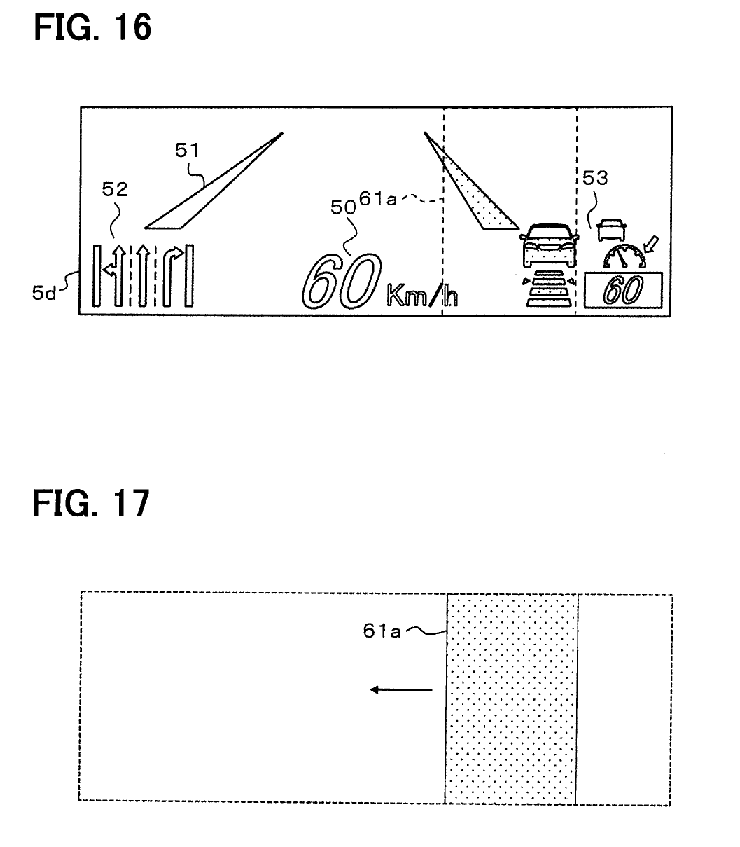

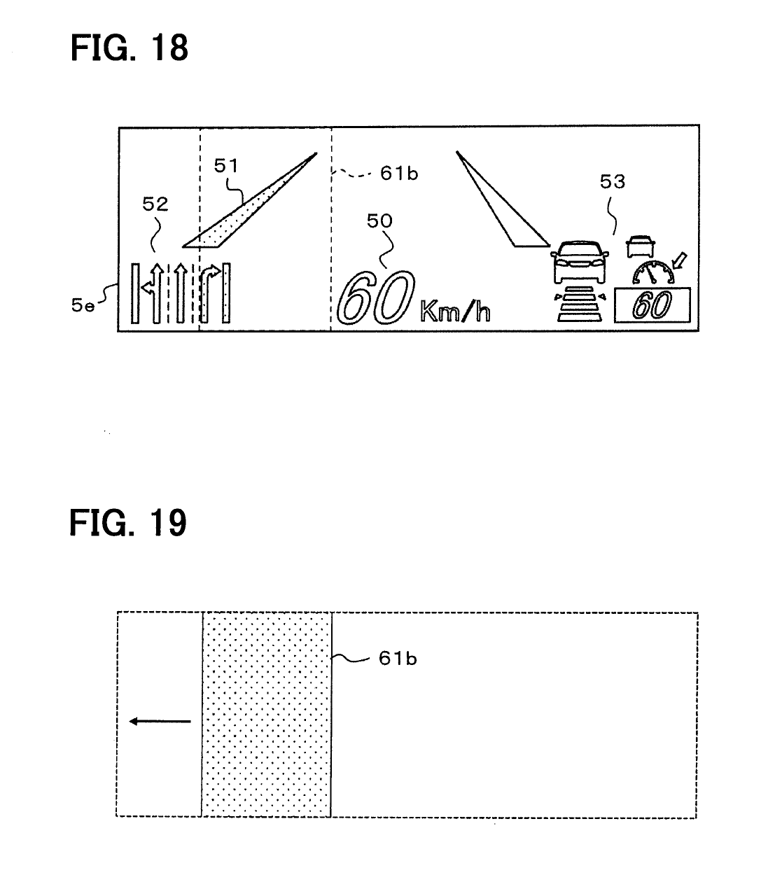

FIGS. 16 to 19 show examples of the display. FIG. 16 shows a screen display state 5d that employs a pattern 61a shown in FIG. 17. FIG. 18 shows a screen display state 5e that employs a pattern 61b shown in FIG. 19. The two patterns are changed to each other. FIGS. 17 and 19 respectively show the patterns 61a and 61b in which the pattern 61 is moved to different positions.

In FIG. 16, a display screen 5d is displayed. In FIG. 16, in the pattern of each of the information items 51 to 53 of the display screen 5a, a part of the pattern with which the pattern 61a located on the right side of the display screen is overlapped is colored. In FIG. 18, a display screen 5d is displayed. In FIG. 18, a colored part is moved to the left. In the actual display, the pattern 61 continuously moves, and each of FIGS. 16 and 18 shows the state where the display position of the pattern 61 continuously moves. After the pattern 61 moves to the left end, the pattern 61 appears again from the right side and moves to the left side. With this configuration, the pattern of each of the information items 51 to 53 on the display screen 5a is displayed in a state of being changed, so that the control apparatus 1 is in the optimization control state.

FIG. 11 shows a changing area pattern 62 indicative of a pattern that changes a pattern of each of information items 51 to 53 displayed on the display screen 5a in another color, similarly to FIG. 10. By expanding the changing area pattern 62 outward from a center point O, the display state of the pattern of each of the information items 51 to 53 on the display screen 5a may be changed. The changing area pattern 62 has a color or a design, which is different from the pattern of each of the information items 51 to 53 on the display screen 5a. The changing area pattern 62 is gradually expanded and the color or the design of the changing area pattern 62 is displayed on the portion overlapping. With this configuration, the display state of the display screen 5a is changed.

As shown in FIG. 11, the changing area pattern 62 has an elliptical shape elongated horizontally so as to fit the shape of the display screen 5a. Alternatively, the changing area pattern 62 may have a rectangular shape, circular shape. Alternatively, the changing area pattern 62 may be provided by multiple concentric rings and the multiple concentric rings are expanded. Alternatively, the changing area pattern 62 may have an arbitrary shape. The changing area pattern 62 may be modified not only to expand but also to shrink. The changing speed of the changing area pattern 62 may be set appropriately. The changing speed may be constant. Alternatively, the changing speed may be appropriately changed.

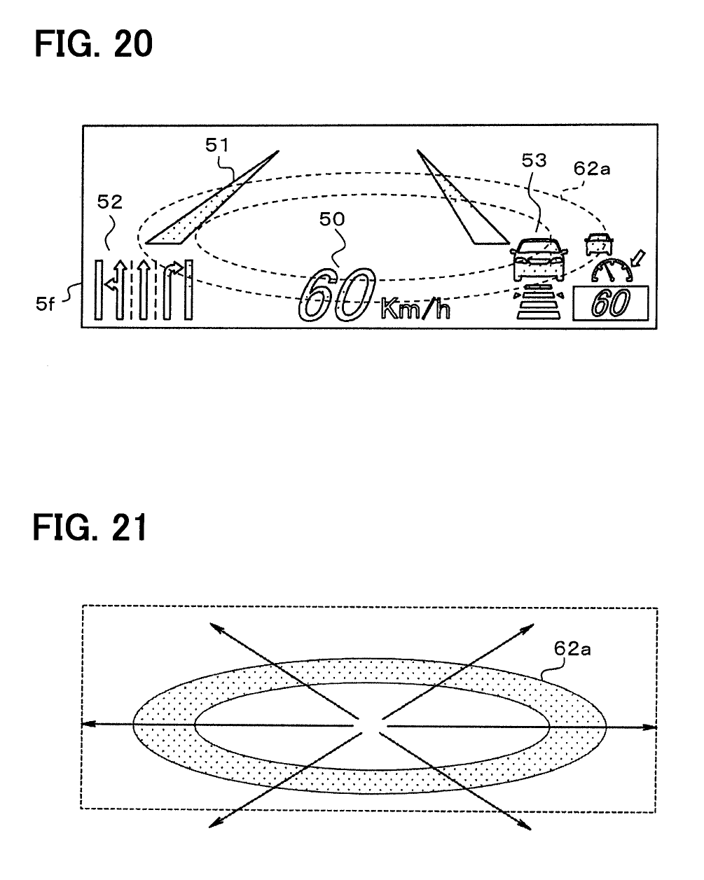

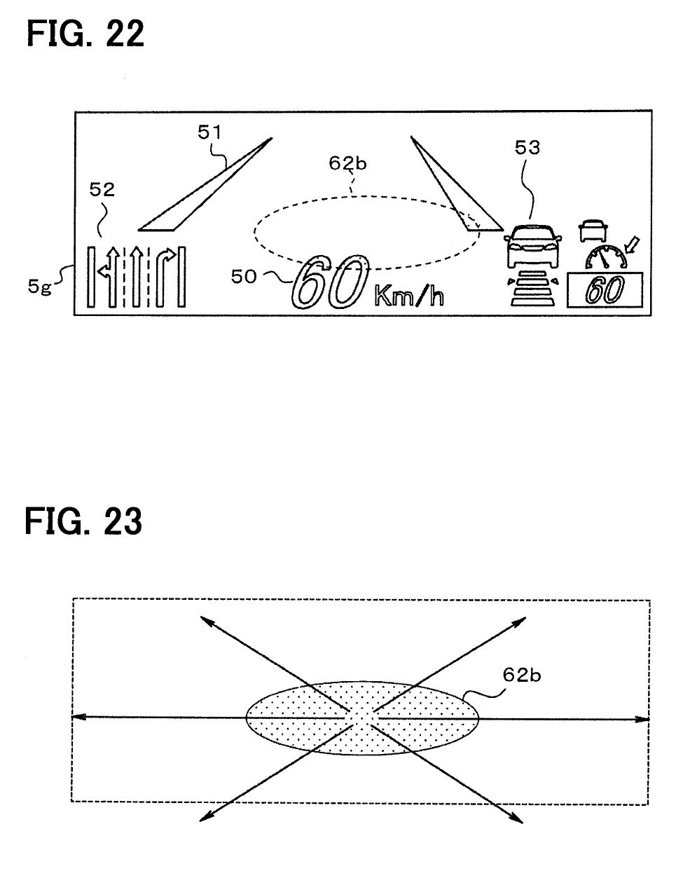

FIGS. 20 to 23 show examples of the display. FIG. 20 shows a screen display state 5f that employs a pattern 62a shown in FIG. 21. FIG. 22 shows a screen display state 5g that employs a pattern 62b shown in FIG. 23. The two patterns are changed to each other. FIGS. 21 and 23 respectively show the patterns 62a and 62b in which the pattern 62 is expanded or shrank.

In FIG. 20, a display screen 5f is displayed. In FIG. 20, in the pattern of each of the information items 51 to 53 of the display screen 5a, a part of the pattern with which the pattern 62a having a ring shape is overlapped is colored. In FIG. 22, a display screen 5g is displayed. In FIG. 22, after the pattern 62a having the ring shape expands and disappears, the pattern 62b is generated. In the actual display, the pattern 62 continuously moves, and each of FIGS. 20 and 22 shows the state where a display position of the pattern 62 continuously expands. With this configuration, the pattern of each of the information items 51 to 53 on the display screen 5a is displayed in a state of being changed, so that the control apparatus 1 is in the optimization control state.

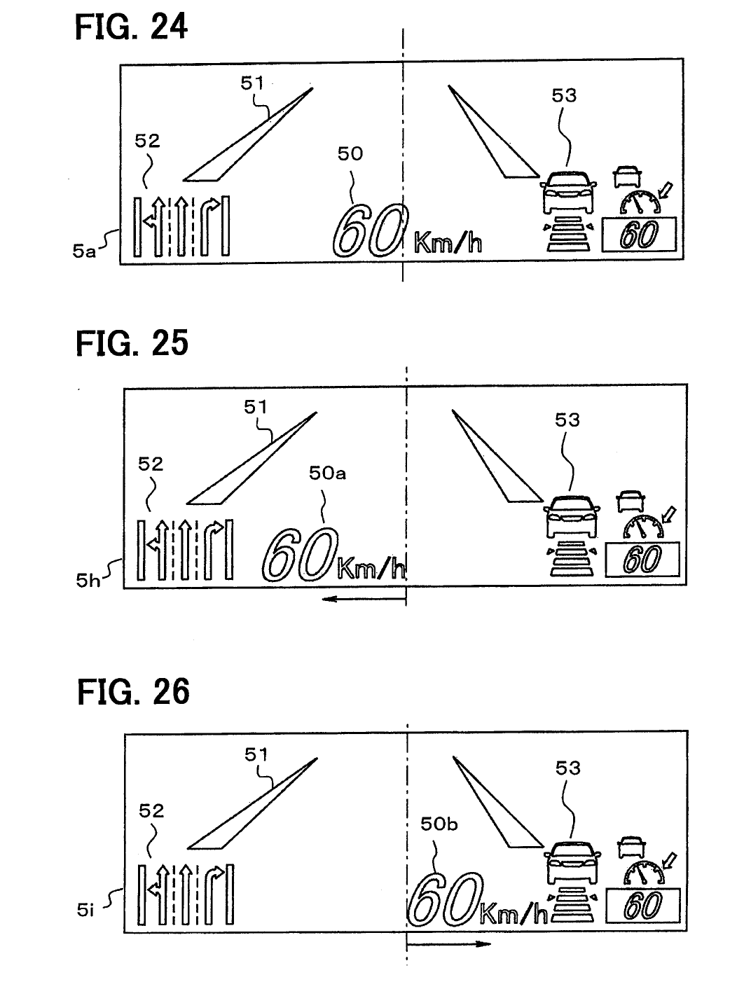

FIGS. 24 to 26 show an optimization control in which a pattern of the speed information item 50 among the information items 51 to 53 of the display screen 5a displayed on the HUD 5 is moved in a lateral direction. FIG. 24 shows a basic position of the information item 50. FIG. 25 shows a display state of the speed information 50a which is moved to left. FIG. 22 shows a display state of the speed information 50a which is moved to right.

In the display operation, after the information item 50 moves from the reference position shown in FIG. 24 to the left, the information item 50 returns to the reference position. In the display operation, after the information item 50 moves from the reference position to right, the information item 50 returns to the reference position. In the actual display, the display operations are repeatedly performed. In this case, the display position of the speed information item 50 may be continuously moved. Alternatively, the display position of the speed information item 50 may be instantaneously moved. The moving speed of the moving area pattern 61 may be set appropriately. The moving speed may be constant. Alternatively, the moving speed may be appropriately changed.

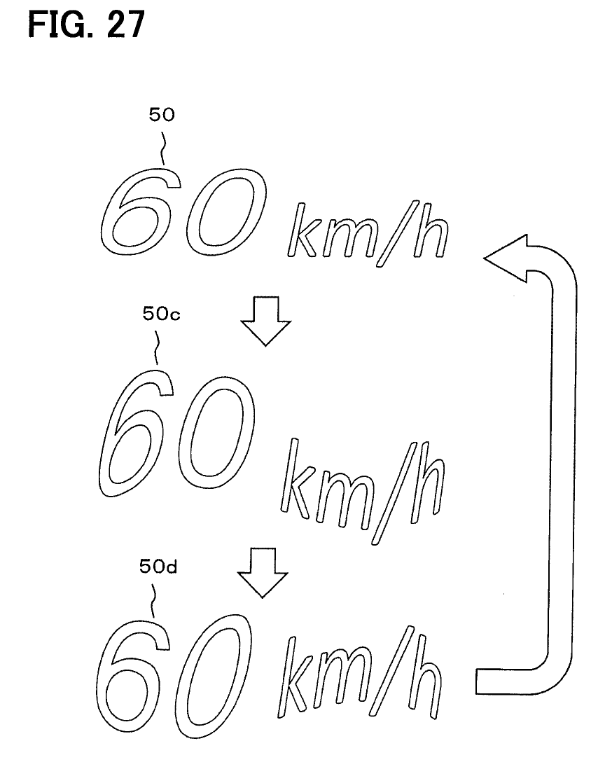

FIG. 27 shows an optimization control in which a pattern of the speed information item 50 among the information items 51 to 53 of the display screen 5a displayed on the HUD 5 is deformed. The upper row of FIG. 27 shows the speed information 50 of the basic state. In the middle row and the lower row of FIG. 27, the display states of the speed information 50c and 50d, which are deformed to be different twisted shapes, are shown.

In the actual display, for example, the state is continuously changed from the reference state shown in the upper row of FIG. 27 to the state of the middle row or the lower row of FIG. 27. Alternatively, the display position of the speed information item 50 may be instantaneously deformed. The deforming speed may be set appropriately. The deforming speed may be constant. Alternatively, the deforming speed may be appropriately changed.

In the configuration according to the first embodiment, when the drive state of the driver is out of the appropriate state and the drive state is capable of being optimized, the stimulation is given to the driver by changing the display manner using the HUD 5 in use. The configuration does not directly communicate the drive state that is out of the appropriate state to the driver, but communicates the drive state by the visual stimulation from the display operation of transmission of the information. Thus, the configuration can reduce annoyance which the driver feels. The configuration can improve the drive state without causing the decrease of attractiveness to the front by the communication of the information.

### Second Embodiment

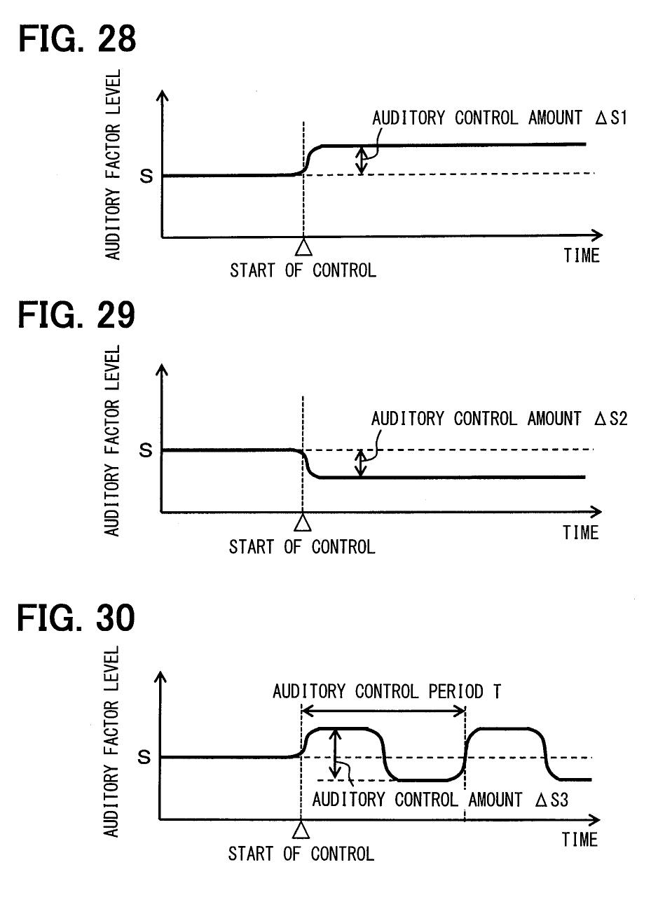

FIGS. 28 to 33 show a vehicle apparatus control device according to a second embodiment, and portions different from the first embodiment will be described below. In this embodiment, the optimization control is performed using the sense of hearing among the five senses as a factor of stimulation to the driver.

In this embodiment, the optimization control is performed by using, for example, the audio apparatus 6 as a provision apparatus of the sense of hearing. As shown in FIG. 4, in the sense of hearing, the factor may include “sound intensity”, “pitch”, “tone color”, “rhythm”, “audible range”, “language”, or the like.

As shown in FIG. 4, each of the factors of the sense of hearing further includes detailed physical factors. The control apparatus 1 performs the optimization control by the sound output operation of the audio apparatus 8 based on the detailed physical factors.

For “sound intensity” of the factor, “sound volume”, “sound pressure”, or the like of the sound, which is output from the speakers 8a and 8b, is changed. For “pitch” of the factor, “frequency” or the like of the sound is changed. For “tone color” of the factor, “sound waveform” or the like is changed. For “rhythm” of the factor, “wavelength” or the like is changed.

For “language” of the factor, the stimulation is capable of being provided to the driver by changing a tone interval or a volume of the language or changing the language to another language. In a change manner of the information, an increase or a decrease of a control amount, a repeat of the change, or the like may be employed.

FIGS. 28 and 29 show manners each of which quantitatively changes a level of the factor related to the sense of hearing. The change is performed, similarly to the quantitative change of the visual factor according to the first embodiment. A level S of the auditory factor may be defined as a constant display level. When the optimization control starts, the level S of the auditory factor is changed by increasing an auditory control amount ΔS1 or decreasing an auditory control amount ΔS2. With this configuration, the sense of hearing among the five senses of the driver is stimulated by changing the level of the factor.

As shown in FIG. 30, the auditory control amount ΔS may be periodically changed. In this case, the auditory control amount ΔS corresponds to amplitude ΔS3 of the change amount, and the change speed may be set as a control period T. The control amount ΔS3 and the control period T may be appropriately changed.

In the optimization control by the change in the above-described control amount, the sound volume, the sound pressure, the pitch, or the cycle of the rhythm, each of which is output from the speakers 8a, 8b is changed.

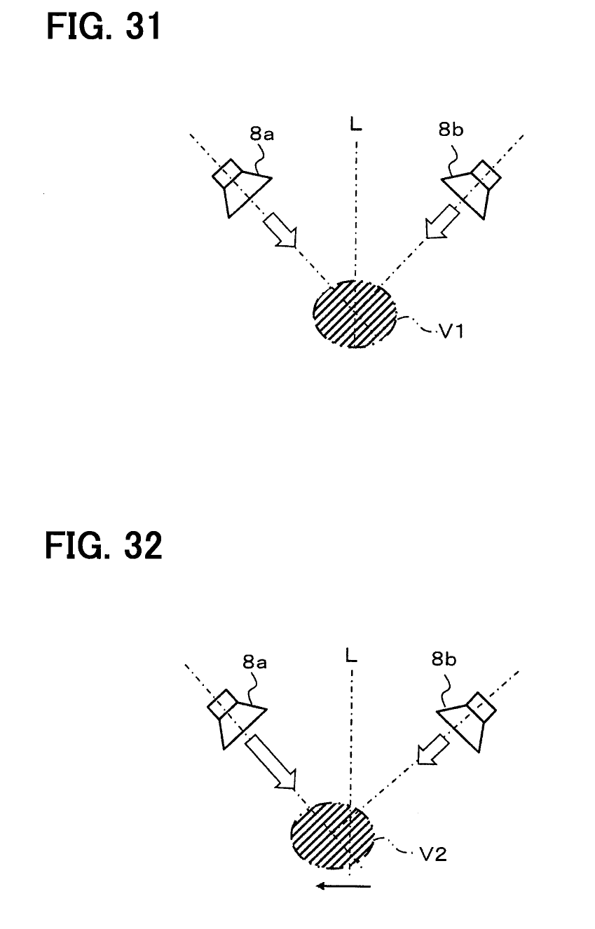

As shown in FIGS. 31 and 32, an optimization control may be performed. In the optimization control, the sound output manner is changed by controlling a state, in FIG. 31, in which the sound volume amounts output from the speakers 8a, 8b on the right and left are the same to a state in which the sound volume amounts are not the same. The change of the sound volume causes a position V1 of the sound image localization to deviate from a center line L. For example, as shown in FIG. 32, the sound volume of the left speaker 8a is larger than the sound volume of the right speaker 8b. In this case, the sound image localization moves to a position V2, which is on the left of the center line L. Alternatively, the sound image localization may move to the right. The sound image localization may repeatedly move to the left and right. Alternatively, the sound image localization may be changed continuously or instantaneously.

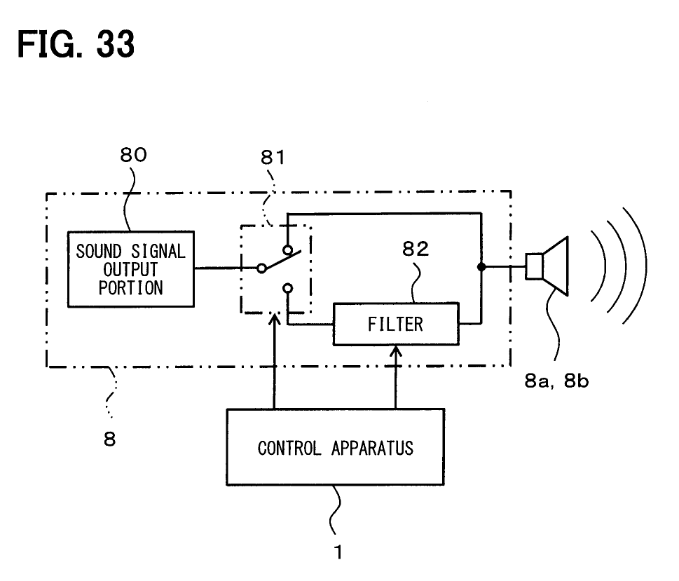

As shown in FIG. 33, the audio apparatus 8 includes a change switch 81 switch and a filter 82 between a sound signal output portion 80 and the speakers 8a, 8b. The use state of the filter 82 is selected by selecting the sound output state by the user, so that the configuration can provide various types of effects, such as the change of the sound quality, the change of the pitch, or the delay.

In the audio apparatus 8 that includes the above-described configuration, the control apparatus 1 controls the switch of the change switch 81, so that the sound signal is changed by passing through the filter 82 or cutting the filter 82. With this configuration, the optimization control such as, the change of the tone color, the change of the pitch can be performed.

With the above-described configuration in the second embodiment, the same advantages as in the first embodiment can be obtained. In this embodiment, the optimization control can be performed by providing the stimulation to the sense of hearing. Thus, the configuration can suppress the deviation of the visual line of the driver provided with the stimulation to the sense of sight.

### Third Embodiment

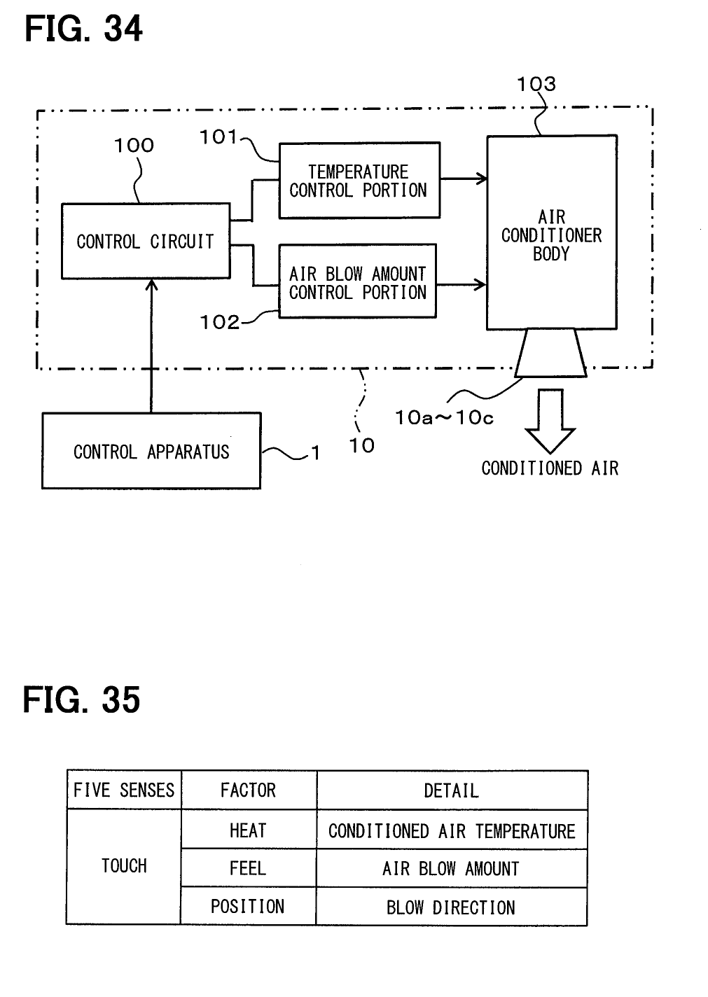

FIGS. 34 to 38 show a vehicle apparatus control device according to a third embodiment, and portions different from the first embodiment will be described below. In this embodiment, the optimization control is performed using the sense of touch among the five senses as a factor of stimulation to the driver.

In this embodiment, the optimization control is performed using, for example, the air conditioner 10 as a provision apparatus of the sense of touch. As shown in FIG. 34, the air conditioner 10 may include a control portion provided by a control circuit 100, a temperature control portion 101, and an air blow amount control portion 102. The control portion can control the air conditioning operation of an air conditioner body 103. The air conditioner body 103 blows out the conditioned air under a condition set by the wind outlets 10a to 10c or the like. The control apparatus 1 transmits the control signal to the control circuit 100, so that the optimization control is performed.

As shown in FIG. 35, in the sense of touch, the factor may include “heat”, “feel”, “position”, or the like. As shown in FIG. 35, each of the factors of the sense of touch further includes detailed physical factors. The control apparatus 1 performs the optimization control by the blow out operation of the air conditioner 10 based on the detailed physical factors.

For “heat” of the factor, the temperature of the conditioned air blown out from the wind outlets 10a to 10c of the air conditioner 10 is changed. For “feel” of the factor, the intensity of the bodily sensation is changed by changing the air blow amount of the air conditioner. For “position” of the factor, the stimulation is capable of being provided for the driver due to the change of the position of the bodily sensation by changing a “blow direction.” The change of the blow direction is performed by switching the wind outlets 10a to 10c, changing the air direction, or the like.

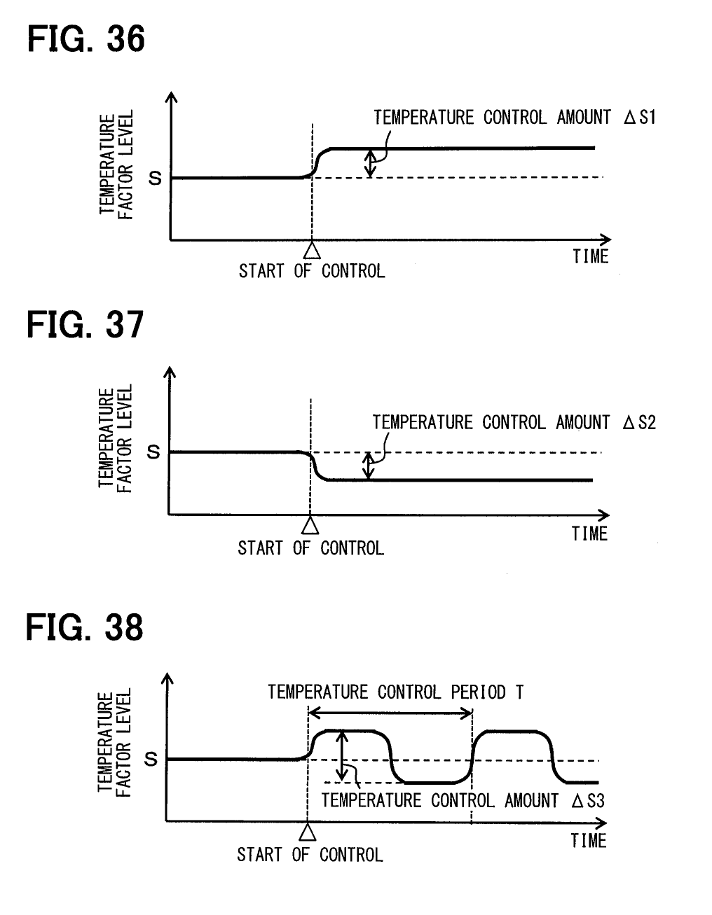

FIGS. 36 to 38 show manners each of which quantitatively changes a level of the factor related to the sense of touch. The change is performed, similarly to the quantitative change of the visual factor according to the first embodiment. A level S of the temperature factor, as the auditory factor, may be defined as a constant display level. When the optimization control starts, the level S of the factor is changed by increasing a temperature control amount ΔS1 or decreasing a temperature control amount ΔS2. With this configuration, the sense of touch among the five senses, such as the bodily sensation, of the driver is stimulated by changing the level of the factor.

With the above-described configuration in the third embodiment, the same advantages as in the first embodiment can be obtained. In this embodiment, the optimization control can be performed by providing the stimulation to the sense of touch. Thus, the configuration can suppress the deviation of the visual line of the driver provided with the stimulation to the sense of sight.

In a case where the optimization control that stimulates the sense of touch is performed, the following manner can be employed in addition to the use of the air conditioner 10. The optimization control may be performed by changing a temperature setting of the seat heater 11 during operation, changing a temperature setting of the steering wheel heater 12 during operation, or the like.

### Other Embodiment

The present disclosure should not be limited to the embodiments described above, and various embodiments may further be implemented without departing from the scope of the present disclosure, and may be modified or expanded as described below.

The optimization control can be performed not only using one of the senses of sight, hearing, and touch among the five senses, but using multiple senses. That is, the optimization control using multiple factors according to the first to third embodiments can be performed.

The optimization control that stimulates one of the five senses may be performed by changing the level or the type using another factor.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A vehicle apparatus control device comprising:
a state detection apparatus configured to detect a drive state of a driver of a vehicle;
a provision apparatus, as a vehicle apparatus, configured to provide information to the driver of the vehicle through one of five senses in a predetermined provision manner; and
an optimization apparatus configured to cause the provision apparatus to provide the information by changing the provision manner when the drive state of the driver detected by the state detection apparatus is out of an appropriate range, and configured to suggest to the driver that the drive state is out of the appropriate range.

2. The vehicle apparatus control device according to claim 1, wherein
the optimization apparatus causes the provision apparatus to suspend a control of changing the provision manner in a case where the drive state of the driver detected by the state detection apparatus is out of the appropriate range after the optimization apparatus causes the provision apparatus to provide the information by changing the provision manner.

3. The vehicle apparatus control device according to claim 1, further comprising
a warning apparatus configured to perform a warning operation in order to restore the drive state of the driver within the appropriate range,
wherein
the optimization apparatus causes the warning apparatus to perform the warning operation in a case where the drive state of the driver detected by the state detection apparatus is out of the appropriate range after the optimization apparatus causes the provision apparatus to provide the information by changing the provision manner.

4. The vehicle apparatus control device according to claim 1, wherein
the optimization apparatus causes the provision apparatus to provide the information by changing the provision manner in a different way in a case where the drive state of the driver detected by the state detection apparatus is within the appropriate range after the optimization apparatus causes the provision apparatus to provide the information by changing the provision manner.

5. The vehicle apparatus control device according to claim 1, wherein:
the provision apparatus includes a display apparatus configured to provide the information using a sense of sight; and
the optimization apparatus causes the display apparatus to provide the information by changing, as the provision manner, a display state of the display apparatus.

6. The vehicle apparatus control device according to claim 5, wherein:
the optimization apparatus causes the display apparatus to provide the information by changing at least one of visual factors in a display pattern of the display apparatus; and
the at least one of visual factors is provided by a color, a shape, a position, a motion, or a character.

7. The vehicle apparatus control device according to claim 1, wherein:
the provision apparatus includes an audio apparatus configured to provide the information using a sense of hearing; and
the optimization apparatus causes the audio apparatus to provide the information by changing, as the provision manner, a sound output state of the audio apparatus.

8. The vehicle apparatus control device according to claim 7, wherein:
the optimization apparatus causes the audio apparatus to provide the information by changing at least one of auditory factors in a sound output of the audio apparatus; and
the at least one of auditory factors is provided by a sound intensity, a pitch, a tone color, a rhythm, an audible range, or a language.

9. The vehicle apparatus control device according to claim 1, wherein
the provision apparatus includes a communication apparatus configured to provide, as bodily sensation information, the information using a sense of touch; and
the optimization apparatus causes the communication apparatus to provide the information by changing, as the provision manner, a temperature information output state of the communication apparatus.

10. The vehicle apparatus control device according to claim 9, wherein:
the optimization apparatus causes the communication apparatus to provide the information by changing at least one of tactile factors in a temperature information output of the communication apparatus; and
the at least one of tactile factors is provided by a temperature change, a temperature conduction position, or a temperature conduction amount.
